(19) United States
(12) Patent Application Publication
(10) Pub. No.: US 2009/0072719 A1
(43) Pub. Date: Mar. 19, 2009

(54) Passivation film and electronic display device including the passivation film

(75) Inventors: Young-nam Kwon, Gunpo-si (KR); Young-gu Lee, Suwon-si (KR); Jong-jin Park, Yongin-si (KR); Hyung-ik Lee, Suwon-si (KR); Sung Heo, Busan (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/078,405

(22) Filed: Mar. 31, 2008

(30) Foreign Application Priority Data
Sep. 19, 2007 (KR) 10-2007-0095411

(51) Int. Cl. H01J 1/63; B32B 7/02; B32B 9/00; B32B 27/36; B32B 27/40; B32B 27/08

(52) U.S. Cl. 313/504; 428/332; 428/688; 428/698; 428/412; 428/473.5

(57) ABSTRACT

Example embodiments relate to a passivation film for protecting an electronic device. The passivation film may include a myelin layer. The myelin layer may have a thickness of about 100 Å to 10 μm. The passivation film may further include an inorganic film. Example embodiments also relate to an electronic display device including a substrate, an organic light-emitting device (OLED) disposed on the substrate, and a myelin layer disposed on the organic light-emitting device. A plurality of myelin layers and a plurality of inorganic films may be alternately stacked on the organic light-emitting device in lieu of a single myelin layer.

### PRIORITY STATEMENT

This application claims priority under 35 U.S.C. §119 to Korean Patent Application No. 10-2007-0095411, filed on Sep. 19, 2007 in the Korean Intellectual Property Office (KIPO), the entire contents of which are incorporated herein by reference.

### BACKGROUND

1. Technical Field

Example embodiments relate to a passivation film for electronic devices and an electronic display device including the passivation film.

2. Description of the Related Art

Exposure to moisture and/or oxygen may decrease the durability of an electronic device (e.g., organic light-emitting device (OLED)). As a result, it may be beneficial to protect an electronic device with a passivation means. A conventional method of protecting an OLED may include coating an OLED with glass. However, this conventional OLED coating method may increase the thickness of a display device and may not be compatible with flexible display devices.

FIG. 1 illustrates a conventional passivation film for reducing or preventing external moisture and/or oxygen from contacting an OLED 160. Referring to FIG. 1, the passivation film may be formed on the OLED 160. The passivation film may have a stacked structure wherein organic layers 142, 132, and 136 may be alternately arranged with inorganic layers 144 and 134. The organic layers 142, 132, and 136 may reduce or prevent damage to the inorganic layers 144 and 134. The organic layers 142, 132, and 136 may be flexible, and the inorganic layers 144 and 134 may reduce or prevent the penetration of moisture and oxygen. Thus, to sufficiently block moisture and oxygen, a conventional passivation film may need a multi-layered structure (e.g., five-layered structure) wherein organic layers 142, 132, and 136 are alternately stacked with inorganic layers 144 and 134. However, the manufacture of a multi-layered passivation film may increase the number of manufacturing processes, thereby also increasing manufacturing costs.

### SUMMARY

Example embodiments relate to a passivation film that may be manufactured with relative ease. The passivation film according to example embodiments may increase the durability of an electronic device. Example embodiments also relate to an electronic display device including the passivation film.

A passivation film according to example embodiments for protecting an electronic device may include a first myelin layer. The first myelin layer may have a thickness of about 100 Å to 10 μm. The passivation film may further include a first inorganic film disposed on the first myelin layer. The inorganic film may be an oxide or a nitride. For instance, the oxide may be an aluminum oxide or a silicon oxide, and the nitride may be a silicon nitride. The first inorganic film may have a thickness of about 100 Å to 10 μm. The passivation film may further include a second myelin layer disposed on the first inorganic film and a second inorganic film disposed on the second myelin layer. The passivation film may further include a plastic film disposed below the first myelin layer. An inorganic film may also be disposed between the plastic film and the first myelin layer.

An electronic display device according to example embodiments may include a substrate having a first surface and a second surface. An organic light-emitting device may be disposed on the first surface of the substrate. A first myelin layer may be disposed on the organic light-emitting device. The electronic display device may further include a first inorganic film disposed on the first myelin layer. A plastic film may be disposed between the organic light-emitting device and the first myelin layer. The electronic display device may further include a second myelin layer, an inorganic film, and/or a plastic film disposed on the second surface of the substrate. The substrate may be formed of glass or plastic.

### BRIEF DESCRIPTION OF THE DRAWINGS

The features and advantages of example embodiments may become more apparent upon review of the detailed description in conjunction with the attached drawings in which:

FIG. 1 is a schematic cross-sectional view of a conventional passivation film;

FIG. 2 is a schematic cross-sectional view of an electronic display device according to example embodiments;

FIG. 3 is a schematic cross-sectional view of a modification of the electronic display device of FIG. 2 according to example embodiments;

FIG. 4 is a schematic cross-sectional view of another electronic display device according to example embodiments;

FIG. 5 is a schematic cross-sectional view of a modification of the electronic display device of FIG. 4 according to example embodiments;

FIG. 6 is a schematic cross-sectional view of another electronic display device according to example embodiments;

FIG. 7 is a schematic cross-sectional view of a modification of the electronic display device of FIG. 6 according to example embodiments;

FIG. 8 is a schematic cross-sectional view of another electronic display device according to example embodiments;

FIG. 9 is a schematic cross-sectional view of a modification of the electronic display device of FIG. 8 according to example embodiments;

FIG. 10 is a graph showing the durability of an OLED when the passivation film is a plastic film (PET), the durability of an OLED when the passivation film includes both a plastic film (PET) and a myelin layer, and the durability of an OLED when the passivation film is formed of glass.

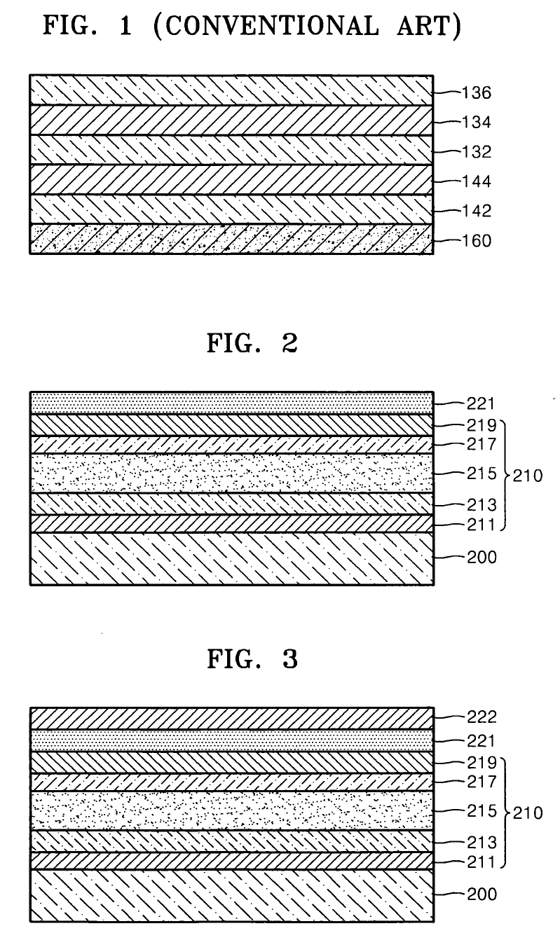

### DETAILED DESCRIPTION OF EXAMPLE EMBODIMENTS

It will be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on,” “directly connected to” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, e.g., “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Example embodiments relate to a passivation film for increasing the durability of an electronic device by reducing or preventing adverse conditions (e.g., moisture and/or oxygen) from coming in contact with the electronic device. For example, a passivation film may be applied to an organic light-emitting device (OLED). However, the passivation film may also be applied to other electronic devices that may be damaged by adverse environmental conditions. Example embodiments will be described in further detail below with reference to the accompanying drawings. In the drawings, like reference numerals may denote like elements. Additionally, the thicknesses of layers and regions may have been exaggerated for clarity.

FIG. 2 is a schematic cross-sectional view of an electronic display device according to example embodiments. Referring to FIG. 2, an electronic display device (e.g., an organic light-emitting display device) according to example embodiments may include a substrate 200, an OLED 210 formed on the substrate 200, and a myelin layer 221 coating the OLED 210. A passivation film protecting the OLED 210 from the external environment may include the myelin layer 221. A glass substrate or a plastic substrate may be used as the substrate 200. When the substrate 200 is formed of plastic, a flexible organic light-emitting display device may be achieved. The OLED 210 may be a top emission type OLED or a bottom emission type OLED. The OLED 210 may be driven in an active or passive matrix manner. Layers that constitute the OLED 210 may be formed by deposition, polymer coating, or inkjet printing.

The OLED 210 may include an anode electrode 211, an emission layer 215, and/or a cathode electrode 219. The anode electrode 211 may be formed of a material having a relatively high conductivity and a relatively high work function. For example, when the OLED 210 is a bottom emission type OLED, the anode electrode 211 may be formed of a transparent conductive material (e.g., indium tin oxide (ITO), indium zinc oxide (IZO), or a relatively thin metal). On the other hand, when the OLED 210 is a top emission type OLED, the anode electrode 211 may be a reflective electrode formed of metal (e.g., aluminum). The cathode electrode 219 may be formed of a metal, an alloy thereof, or another electrically conductive compound having a relatively low work function. For example, when the OLED 210 is a bottom emission type OLED, the cathode electrode 219 may be a reflective electrode formed of metal (e.g., aluminum). On the other hand, when the OLED 210 is a top emission type OLED, the cathode electrode 219 may be formed of a transparent conductive material (e.g., ITO, IZO, or a relatively thin metal).

The emission layer 215 may be formed between the anode electrode 211 and the cathode electrode 219. The emission layer 215 may emit light of a predetermined color by combining holes flowing in from the anode electrode 211 with electrons flowing in from the cathode electrode 219. The emission layer 215 may be a blue, green, or red emission layer. Alternatively, the emission layer 215 may be a white emission layer including two complementary color emission layers or three red, green, and blue emission layers. A hole injection layer (HIL) 213 for improving hole injection may be interposed between the anode electrode 211 and the emission layer 215. An electron injection layer (EIL) 217 for improving electron injection may be interposed between the cathode electrode 219 and the emission layer 215. Although not shown in FIG. 2, a hole transporting layer (HTL) for facilitating hole transportation may be interposed between the HIL 213 and the emission layer 215, and an electron transporting layer (ETL) for facilitating electron transportation may be interposed between the EIL 217 and the emission layer 215.

Myelin is a dielectric phospolipid layer that may surround the axons of neurons. Myelin may perform an insulating function with regard to nerve cells and is a hydrophobic organic material composed of lipid fats and proteins. For example, myelin may be composed of about 80% lipid fat and about 20% protein. Myelin may function as a neurotransmitter by increasing the speed at which impulses propagate along the myelinated fiber. However, as discussed herein, myelin may also have beneficial use with regard to passivation layers for an electronic device.

The myelin layer 221 may be formed on the upper surface of the cathode electrode 219 so as to cover the cathode electrode 219. The myelin layer 221 may have a thickness of about 100 Å˜10 μm. The myelin layer 221 may protect the OLED 210 from adverse external conditions (e.g., moisture and/or oxygen). Because the myelin layer 221 is formed of an organic material, when a plastic substrate is used as the substrate 200, a relatively thin, flexible organic light-emitting display device may be realized. The myelin layer 221 may be formed by melting myelin in a solvent, wherein chloroform and methanol may be mixed at a ratio of about 1:1. The melted myelin may be coated on the upper surface of the cathode electrode 219 by a suitable coating method (e.g., spin coating, lamination).

FIG. 3 is a schematic cross-sectional view of a modification of the electronic display device of FIG. 2 according to example embodiments. The electronic display device of FIG. 3 will be described with regard to the differences between the electronic display device of FIG. 3 and the electronic display device of FIG. 2. Referring to FIG. 3, the myelin layer 221 may be formed on the upper surface of the OLED 210, and an inorganic film 222 may be formed on the myelin layer 221. The inorganic film 222 may have a thickness of about 100 Å˜10 μm. The inorganic film 222 may reduce or prevent external moisture and/or oxygen from contacting the OLED 210. The inorganic film 222 may be formed of an oxide (e.g., aluminum oxide, silicon oxide) or a nitride (e.g., silicon nitride), although example embodiments are not limited thereto. To enhance the protection of the OLED 210 from external moisture and/or oxygen, a plurality of myelin layers 221 and a plurality of inorganic films 222 may be alternately stacked on the upper surface of the OLED 210.

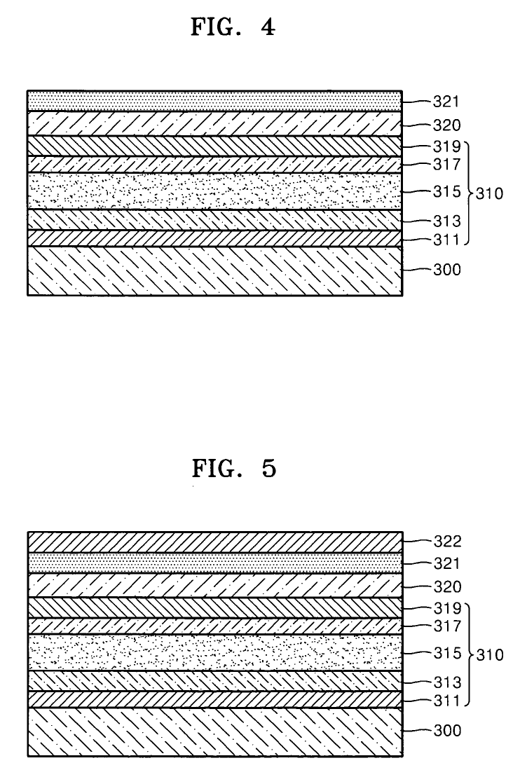

FIG. 4 is a schematic cross-sectional view of another electronic display device according to example embodiments. The electronic display device of FIG. 4 will be described with regard to the differences between the electronic display device of FIG. 4 and previous example embodiments. Referring to FIG. 4, the electronic display device (e.g., organic light-emitting display device) according to example embodiments may includes a substrate 300, an OLED 310 formed on the substrate 300, a plastic film 320 covering the OLED 310, and a myelin layer 321 formed on the plastic film 320. The plastic film 320 and the myelin layer 321 may constitute a passivation film for reducing or preventing the exposure of the OLED 310 to external moisture and/or oxygen. A glass substrate or a plastic substrate may be used as the substrate 300. The OLED 310 may be, as described above, a top emission type OLED or a bottom emission type OLED and may be driven in an active or passive matrix manner.

The OLED 310 may include an anode electrode 311, an emission layer 315, and a cathode electrode 319 sequentially stacked on the substrate 300. An HIL 313 may be interposed between the anode electrode 311 and the emission layer 315, and an EIL 317 may be interposed between the cathode electrode 319 and the emission layer 315. Although not shown in FIG. 4, an HTL may be interposed between the HIL 313 and the emission layer 315, and an ETL may be interposed between the EIL 317 and the emission layer 315.

As discussed above, a plastic film 320 and a myelin layer 321 may be sequentially formed on the upper surface of the cathode electrode 319. The plastic film 320 may be formed of polyethylene naphthalate (PEN), polyethylene terephthalate (PET), polycarbonate (PC), polyacrylate (PAR), polyether sulfone (PES), and/or polyimide (PI), although example embodiments are not limited thereto. The myelin layer 321 formed on the upper surface of the plastic film 320 may have a thickness of about 100 Å˜10 μm. The myelin layer 321 may be formed by melting myelin in a solvent, wherein chloroform and methanol may be mixed at a ratio of about 1:1. The melted myelin may be coated on the upper surface of the plastic film 320 by a suitable coating method (e.g., spin coating, lamination).

FIG. 5 is a schematic cross-sectional view of a modification of the electronic display device of FIG. 4 according to example embodiments. The electronic display device of FIG. 5 will be described with regard to the differences between the electronic display device of FIG. 5 and the electronic display device of FIG. 4. Referring to FIG. 5, the myelin layer 321 may be formed on the upper surface of the plastic film 320 covering the OLED 310, and an inorganic film 322 may be formed on the upper surface of the myelin layer 321. The inorganic film 322 may have a thickness of about 100 Å˜10 μm. The inorganic film 322 may help reduce or prevent external moisture and/or oxygen from reaching the OLED 310. The inorganic film 322 may be formed of an oxide (e.g., aluminum oxide, silicon oxide) or a nitride (e.g., silicon nitride), although example embodiments are not limited thereto. To enhance the protection of the OLED 310 from external moisture and/or oxygen, a plurality of myelin layers 321 and a plurality of inorganic films 322 may be alternately stacked on the plastic film 320.

Although FIG. 5 illustrates the myelin layer 321 disposed on the plastic film 320 and the inorganic film 322 disposed on the myelin layer 321, it should be noted that the inorganic film 322, the myelin layer 321, and the plastic film 320 may be stacked in different combinations. For instance, the inorganic film 322 may be formed on the plastic film 320, and the myelin layer 321 may be formed on the inorganic film 322. Additionally, a plurality of inorganic films 322 and a plurality of myelin layers 321 may be alternately stacked on the plastic film 320.

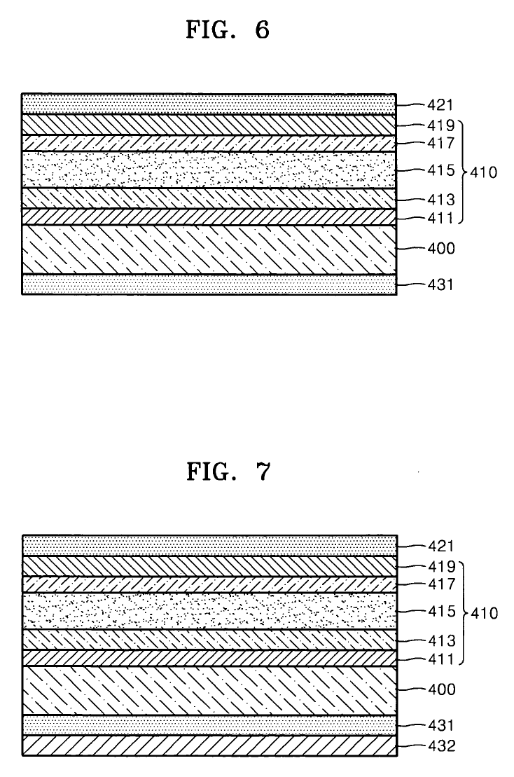

FIG. 6 is a schematic cross-sectional view of another electronic display device according to example embodiments. The electronic display device (e.g., organic light-emitting display device) of FIG. 6 will be described with regard to the differences between the electronic display device of FIG. 6 and previous example embodiments. Referring to FIG. 6, the electronic display device according to example embodiments may include a substrate 400, an OLED 410 formed on the substrate 400, a first myelin layer 421 covering the OLED 410, and a second myelin layer 431 formed on the lower surface of the substrate 400. The first and second myelin layers 421 and 431 may constitute a passivation film for reducing or preventing the exposure of the OLED 410 to external moisture and/or oxygen. A glass substrate or a plastic substrate may be used as the substrate 400. The OLED 400 may be, as described above, a top emission type OLED or a bottom emission type OLED and may be driven in an active or passive matrix manner.

The OLED 410 may include an anode electrode 411, an emission layer 415, and a cathode electrode 419 sequentially stacked on the substrate 400. An HIL 413 may be interposed between the anode electrode 411 and the emission layer 415, and an EIL 417 may be interposed between the cathode electrode 419 and the emission layer 415. Although not shown in FIG. 6, an HTL may be interposed between the HIL 413 and the emission layer 415, and an ETL may be interposed between the EIL 417 and the emission layer 415.

The first myelin layer 421 may be formed on the upper surface of the cathode electrode 419 so as to cover the cathode electrode 419. The first myelin layer 421 may have a thickness of about 100 Å˜10 μm. Although not shown in FIG. 6, an inorganic film may be formed on the first myelin layer 421. The inorganic film may have a thickness of about 100 Å˜10 μm. The inorganic film may be formed of an oxide (e.g., aluminum oxide, silicon oxide) or a nitride (e.g., silicon nitride), although example embodiments are not limited thereto. To enhance the protection of the OLED 410 from external moisture and/or oxygen, a plurality of first myelin layers 421 and a plurality of inorganic films may be alternately stacked on the upper surface of the OLED 410.

The second myelin layer 431 may be formed on the lower surface of the substrate 400. The second myelin layer 431 may have a thickness of about 100 Å˜10 μm. The second myelin layer 431 may be formed by melting myelin in a solvent, wherein chloroform and methanol may be mixed at a ratio of about 1:1. The melted myelin may be coated on the lower surface of the substrate 400 by a suitable coating method (e.g., spin coating, lamination). Although FIG. 6 illustrates that the second myelin layer 431 may be formed on the lower surface of the substrate 400, an inorganic film (not shown) may also be formed on the lower surface of the substrate 400 in lieu of the second myelin layer 431. Such an inorganic film may have a thickness of about 100 Å˜10 μm. Consequently, the second myelin layer 431 or the inorganic film (not shown) formed on the lower surface of the substrate 400 may reduce or prevent external moisture and/or oxygen from reaching the OLED 410 via the substrate 400. The second myelin layer 431 or the inorganic film may be beneficial when the substrate 400 is a plastic substrate.

FIG. 7 is a schematic cross-sectional view of a modification of the electronic display device of FIG. 6 according to example embodiments. The electronic display device of FIG. 7 will be described with regard to the differences between the electronic display device of FIG. 7 and the electronic display device of FIG. 6. Referring to FIG. 7, the first myelin layer 421 may be formed on the upper surface of the OLED 410 formed on the substrate 400. The second myelin layer 431 may be formed on the lower surface of the substrate 400, and an inorganic film 432 may be formed on the lower surface of the second myelin layer 431. The inorganic film 432 may have a thickness of about 100 Å˜10 μm. To enhance the protection of the OLED 410 from external moisture and/or oxygen, a plurality of second myelin layers 431 and a plurality of inorganic films 432 may be alternately stacked on the lower surface of the substrate 400.

Although FIG. 7 illustrates that the second myelin layer 431 may be formed on the lower surface of the substrate 400 with the inorganic film 432 formed on the lower surface of the second myelin layer 431, it should be noted that the order of the second myelin layer 431 and the inorganic film 432 may be switched. For instance, the inorganic film 432 may be formed on the lower surface of the substrate 400, and the second myelin layer 431 may be formed on the lower surface of the inorganic film 432. Additionally, a plurality of inorganic films 432 and a plurality of second myelin layers 431 may be alternately stacked on the lower surface of the substrate 400.

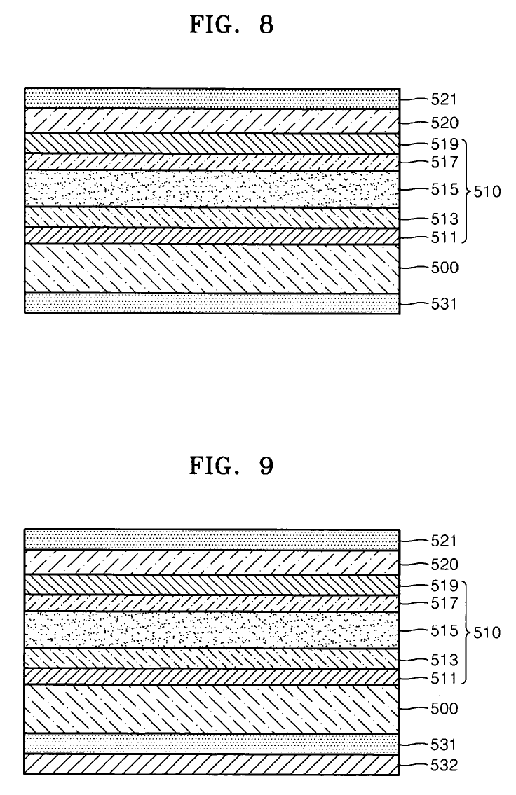

FIG. 8 is a schematic cross-sectional view of an electronic display device according to example embodiments. The electronic display device (e.g., organic light-emitting display device) of FIG. 8 will be described with regard to the differences between the electronic display device of FIG. 8 and previous example embodiments. Referring to FIG. 8, the electronic display device may include a substrate 500, an OLED 510 formed on the substrate 500, a plastic film 520 covering the OLED 510, a first myelin layer 521 formed on the plastic film 520, and a second myelin layer 531 formed on the lower surface of the substrate 500. The plastic film 520 and the first and second myelin layers 521 and 531 may constitute a passivation film for reducing or preventing the exposure of the OLED 510 to external moisture and/or oxygen. A glass substrate or a plastic substrate may be used as the substrate 500. The OLED 510 may be, as described above, a top emission type OLED or a bottom emission type OLED and may be driven in an active or passive matrix manner.

The OLED 510 may include an anode electrode 511, an emission layer 515, and a cathode electrode 519 sequentially stacked on the substrate 500. An HIL 513 may be interposed between the anode electrode 511 and the emission layer 515, and an EIL 517 may be interposed between the cathode electrode 519 and the emission layer 515. Although not shown in FIG. 8, an HTL may be interposed between the HIL 513 and the emission layer 515, and an ETL may be interposed between the EIL 517 and the emission layer 515.

As discussed above, the plastic film 520 and the first myelin layer 521 may be sequentially formed on the upper surface of the cathode electrode 519. The plastic film 520 may be formed of PEN, PET, PC, PAR, PES, and/or PI, although example embodiments are not limited thereto. The first myelin layer 521 may have a thickness of about 100 Å˜10 μm. Although not shown in FIG. 8, an inorganic film may be formed on the first myelin layer 521. The inorganic film may have a thickness of about 100 Å˜10 μm. The inorganic film may be formed of an oxide (e.g., aluminum oxide, silicon oxide) or a nitride (e.g., silicon nitride), although example embodiments are not limited thereto. To enhance the protection of the OLED 510 from external moisture and/or oxygen, a plurality of first myelin layers 521 and a plurality of inorganic films may be alternately stacked on the upper surface of the OLED 510. Alternatively, the inorganic film (not shown) may be formed on the plastic film 520, and the first myelin layer 521 may be formed on the inorganic film. Additionally, a plurality of inorganic films and a plurality of first myelin layers 521 may be alternately stacked on the plastic film 520.

The second myelin layer 531 may be formed on the lower surface of the substrate 500. The second myelin layer 531 may have a thickness of about 100 Å˜10 μm. Although FIG. 8 illustrates that the second myelin layer 531 may be formed on the lower surface of the substrate 500, an inorganic film may also be formed on the lower surface of the substrate 500 in lieu of the second myelin layer 531. Such an inorganic film may have a thickness of about 100 Å˜10 μm. Consequently, the second myelin layer 531 or the inorganic film (not shown) formed on the lower surface of the substrate 500 may reduce or prevent external moisture and/or oxygen from reaching the OLED 510 via the substrate 500. The second myelin layer 531 or the inorganic film may be beneficial when the substrate 500 is a plastic substrate.

FIG. 9 is a schematic cross-sectional view of a modification of the electronic display device of FIG. 8 according to example embodiments. The electronic display device of FIG. 9 will be described with regard to the differences between the electronic display device of FIG. 9 and the electronic display device of FIG. 8. Referring to FIG. 9, the plastic film 520 and the first myelin layer 521 may be sequentially formed on the upper surface of the OLED 510 formed on the substrate 500. The second myelin layer 531 may be formed on the lower surface of the substrate 500, and an inorganic film 532 may be formed on the lower surface of the second myelin layer 531. The inorganic film 532 may have a thickness of about 100 Å˜10 μm. To enhance the protection of the OLED 510 from external moisture and/or oxygen, a plurality of second myelin layers 531 and a plurality of inorganic films 532 may be alternately stacked on the lower surface of the substrate 500. Although FIG. 9 illustrates that the second myelin layer 531 may be formed on the lower surface of the substrate 500 with the inorganic film 532 formed on the lower surface of the second myelin layer 531, the order of the second myelin layer 531 and the inorganic film 532 may be switched. For instance, the inorganic film 532 may be formed on the lower surface of the substrate 500, and the second myelin layer 531 may be formed on the lower surface of the inorganic film 532. Additionally, a plurality of inorganic films 532 and a plurality of second myelin layers 531 may be alternately stacked on the lower surface of the substrate 500.

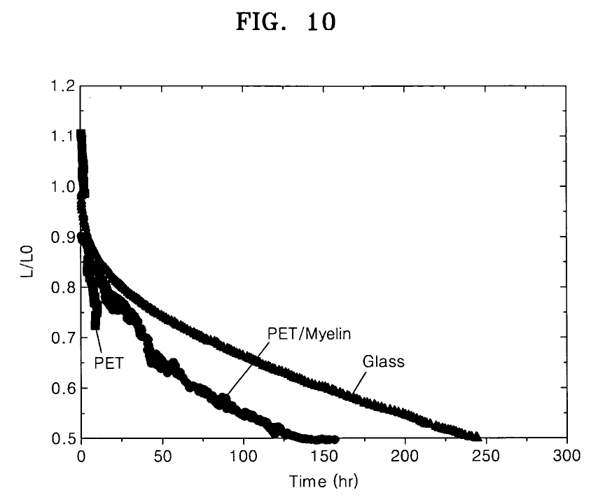

FIG. 10 is a graph showing the durability of an OLED when the passivation film is a plastic film (PET), the durability of an OLED when the passivation film includes both a plastic film (PET) and a myelin layer, and the durability of an OLED when the passivation film is formed of glass. An experiment was performed with an electronic display device having a glass substrate, a bottom emission type OLED, and a plastic film formed of PET. A myelin layer was formed on the plastic film, and the thickness of the myelin layer was about 2000 Å. The results of the experiment are shown in FIG. 10. Referring to FIG. 10, LO and L denote the initial brightness of the OLED and the brightness of the OLED in relation to time, respectively. As illustrated in FIG. 10, when the passivation film was formed of glass, the durability of the OLED was the longest. In contrast, when the passivation film was a plastic film (PET), the durability of the OLED was the shortest. On the other hand, when the passivation film included both a plastic film and a myelin layer, the durability of the OLED was about 60% of the durability of the OLED when the passivation film was formed of glass. Thus, when a passivation film includes both a plastic film and a myelin layer, the durability of the OLED may be longer than when the passivation film is only a plastic film. Additionally, the durability of the OLED may increase with the thickness of the myelin layer. Although the durability of the OLED was longer when the passivation film was formed of glass, it may be more difficult to realize a flexible organic light-emitting display device with such a passivation film. However, when the passivation film includes both a plastic film and a myelin layer, the durability of the OLED may be higher (with regard to a plastic passivation film), and a flexible organic light-emitting display device may also be realized.

While example embodiments have been disclosed herein, it should be understood that other variations may be possible. Such variations are not to be regarded as a departure from the spirit and scope of example embodiments of the present disclosure, and all such modifications as would be obvious to one skilled in the art are intended to be included within the scope of the following claims.

What is claimed is:

1. A passivation film for protecting an electronic device, comprising a first myelin layer.

2. The passivation film of claim 1, wherein the first myelin layer has a thickness of about 100 Å to 10 μm.

3. The passivation film of claim 1, further comprising:
a first inorganic film on the first myelin layer.

4. The passivation film of claim 3, wherein the inorganic film is an oxide or a nitride.

5. The passivation film of claim 4, wherein the oxide is an aluminum oxide or a silicon oxide, and the nitride is a silicon nitride.

6. The passivation film of claim 3, wherein the first inorganic film has a thickness of about 100 Å to 10 μm.

7. The passivation film of claim 3, further comprising:
a second myelin layer on the first inorganic film; and
a second inorganic film on the second myelin layer.

8. The passivation film of claim 1, further comprising:
a plastic film below the first myelin layer.

9. The passivation film of claim 8, wherein the plastic film includes at least one of a polyethylene naphthalate, a polyethylene terephthalate, a polycarbonate, a polyacrylate, a polyether sulfone, and a polyimide.

10. The passivation film of claim 8, further comprising:
an inorganic film on the first myelin layer.

11. The passivation film of claim 8, further comprising:
an inorganic film between the plastic film and the first myelin layer.

12. An electronic display device comprising:
a substrate having a first surface and a second surface;
an organic light-emitting device on the first surface of the substrate; and
a first myelin layer on the organic light-emitting device.

13. The device of claim 12, wherein the first myelin layer has a thickness of about 100 Å to 10 μm.

14. The device of claim 12, further comprising:
a first inorganic film on the first myelin layer.

15. The device of claim 14, wherein the first inorganic film is an oxide or a nitride.

16. The device of claim 15, wherein the oxide is an aluminum oxide or a silicon oxide, and the nitride is a silicon nitride.

17. The device of claim 14, wherein the first inorganic film has a thickness of about 100 Å to 10 μm.

18. The device of claim 14, further comprising:
a second myelin layer on the first inorganic film; and
a second inorganic film on the second myelin layer.

19. The device of claim 12, further comprising:
a plastic film between the organic light-emitting device and the first myelin layer.

20. The device of claim 19, wherein the plastic film includes at least one of a polyethylene naphthalate, a polyethylene terephthalate, a polycarbonate, polyacrylate, a polyether sulfone, and a polyimide.

21. The device of claim 19, further comprising:
an inorganic film on the first myelin layer.

22. The device of claim 19, further comprising:
an inorganic film between the plastic film and the first myelin layer.

23. The device of claim 12, further comprising:
at least one of a second myelin layer, an inorganic film, and a plastic film on the second surface of the substrate.

24. The device of claim 12, wherein the substrate is glass or plastic.
